(19) United States
(12) Patent Application Publication
(10) Pub. No.: US 2022/0067627 A1
(43) Pub. Date: Mar. 3, 2022

(54) SELF-ADAPTIVE KEY PERFORMANCE INDICATOR EXTRACTION

(71) Applicant: INTERNATIONAL BUSINESS MACHINES CORPORATION, ARMONK, NY (US)

(72) Inventors: Li Cao, Beijing (CN); Qiang Qin, Beijing (CN); Rui Wang, Xi'an (CN); Jing James Xu, Xi'an (CN)

(21) Appl. No.: 17/009,966

(22) Filed: Sep. 2, 2020

(51) Int. Cl. G06Q 10/06; H04L 12/24; H04L 12/26; G06F 17/18

(52) U.S. Cl. CPC G06Q 10/06393; G06F 17/18; H04L 43/16; H04L 41/5009

(57) ABSTRACT

A method, system, and computer program product are provided for key performance indicator (KPI) extraction. A baseline value and times series data are received. The time series data includes logs, performance data, and operational data from one or more servers. The time series data is embedded to a vector. A multi-tier list of key KPI values is created. The key KPI value having a least cumulative absolute error is identified.

### BACKGROUND

Embodiments of the invention generally relate to computer systems, and more specifically to artificial intelligence for IT operations (AIOps).

The systems, services, and applications in a large enterprise produce large volumes of log and performance data. When analyzing system performance, it can be challenging for a systems administrator to determine which key performance indicators are most influential on system performance.

A prediction model that correlates between performance and key performance indicators can assist the systems administrator identify the key performance indicators that influence system performance. With that information, the system administrator can appropriately tune the system without trial and error inherent in more manual approaches.

### SUMMARY

Among other things, a method is provided. The method includes receiving a baseline value and receiving time series data. The time series data includes logs, performance data, and operational data from one or more servers. The time series data is embedded to a vector. A multi-tier list of key KPI values is created. The key KPI value having the least cumulative absolute error is identified.

Embodiments are further directed to computer systems and computer program products having substantially the same features as the above-described computer-implemented method.

Additional features and advantages are realized through the techniques described herein. Other embodiments and aspects are described in detail herein. For a better understanding, refer to the description and to the drawings.

### BRIEF DESCRIPTION OF THE SEVERAL VIEWS OF THE DRAWINGS

The subject matter which is regarded as the present invention is particularly pointed out and distinctly claimed in the claims at the conclusion of the specification. The foregoing and other features and advantages are apparent from the following detailed description taken in conjunction with the accompanying drawings in which:

FIG. 1 is a functional block diagram of an illustrative system, according to an embodiment of the present invention;

FIG. 2 is a workflow of key performance indicator extraction; and

FIG. 3 is a workflow of key performance indicator validation.

### DETAILED DESCRIPTION

The present disclosure relates generally to the field of artificial intelligence for IT operations (AIOps). AIOps refers to the use of big data analytics, machine learning (ML) and other artificial intelligence (AI) technologies to automate the identification and resolution of information technology (IT) issues.

Key performance indicators define a set of values against which to measure. These raw sets of values, which can be fed to systems that aggregate the data, are called indicators. The key performance indicators (KPI) provide objective evidence of progress towards achieving a desired result. In other words, the KPI are already defined and are applied to measure progress toward a goal. In contrast, embodiments of the present invention analyze aggregated data to predict the best KPI to use as input in measuring the progress towards the goal.

In current practice, identifying the KPI which influence system performance may be based largely on the expertise and experience of the systems administrator. Resolving system issues may require accessing several silos of administration tools to analyze the large volume of logs and other output, from the various servers, applications, operating systems, etc. The results from the analyzes are then combined to obtain a result. Therefore, the results may vary, depending on the expertise of the particular systems administrator. Embodiments of the present invention tend to accurately predict which KPI influences system performance by extracting key variables in time series, estimating the trend, selecting important regression predictors and combining the results in a prediction calculation.

Embodiments of the invention will now be described in more detail in connection with the Figures.

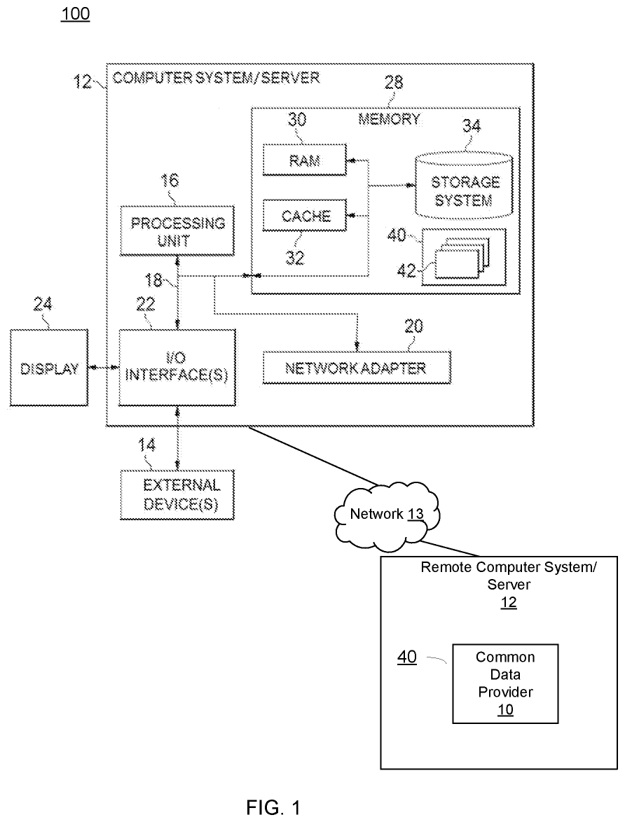

FIG. 1 is a functional block diagram of an illustrative KPI extraction system 100, according to an embodiment of the invention.

As shown, the KPI extraction system 100 includes one or more computer system/servers (server) 12 and remote computer system/servers (remote server) 12. References to the server 12 also apply to the remote server 12, unless specifically stated otherwise. The server 12 may include any computer capable of executing the functions of hosting several applications; receiving large volumes of log and similar data (e.g., terabytes or more) from the hardware, operating system, and applications; performing statistical analysis on the log and similar data; and extracting the KPI affecting system performance.

The functions and processes of server 12 may be described in the context of computer system-executable instructions, such as program modules, routines, objects, data structures, and logic, etc. that perform particular tasks or implement particular abstract data types. The server 12 can be part of a distributed cloud computing environment, where tasks are performed by remote processing devices, such as remote server 12, that are linked through a communications network, such as network 13. In a distributed cloud computing environment, program modules may be located in the system storage of the remote server 12, the storage system 34 of the server 12, or both. Similarly, program modules may be executed on either the server 12, the remote server 12, or both.

As shown in FIG. 1, the server 12 may include, but are not limited to, one or more processors or processing units 16, a system memory 28, and a bus 18 that couples various system components including system memory 28 to processing unit 16.

Bus 18 represents one or more of several types of bus structures, including a memory bus or memory controller, a peripheral bus, an accelerated graphics port, and a processor or local bus using any of a variety of bus architectures.

The server 12 typically includes a variety of computer system readable media. Such media may be any available media that is accessible by computer system/server 12, and it includes both volatile and non-volatile media, removable and non-removable media.

The memory 28 can include computer system readable media in the form of volatile memory, such as random access memory (RAM) 30 and/or cache memory 32. The server 12 may further include other removable/non-removable, volatile/non-volatile computer system storage media. For example, storage system 34 can include a non-removable, non-volatile magnetic media, e.g., a “hard drive” and an optical disk drive for reading from or writing to a removable, non-volatile optical disk such as a CD-ROM, DVD-ROM or other optical media. Each device in the storage system 34 can be connected to bus 18 by one or more data media interfaces, such as I/O interface 22.

Each program 40 (one of which is shown) represents one of a plurality of programs that are stored in the storage system 34 and are loaded into the memory 28 for execution. A program 40 includes an instance of an operating system, an application, a system utility, a common data provider utility, or similar. Each program 40 includes one or more modules 42. In the present invention, the KPI extraction program is an example of the program 40. For example, the KPI extraction program 40 includes a KPI extractor module 42, a KPI validation module 42, and one or more statistical modules 42 that provide Bayesian Structured Times Series, Spike and Slab regression, etc. The common data provider (CDP) 10, shown as a program 40 on the remote server 12, is a system component that gathers data from multiple sources, such as performance records, system logs, and application logs. The CDP 10 streams the gathered data in real time, near real time or in batch to one or more destinations, such as the KPI extraction program 40, for analysis. The streamed CDP 10 data may be stored in system storage 34 for pending analysis by the KPI extraction program 40. Several configurations of the CDP 10, the KPI extractor program 40 and the sources of the data to be analyzed are possible. For example, the CDP 10, the KPI extractor program 40, and the sources of the data may all reside on the same server 12. Alternatively, the CDP 10 may reside on the remote server 12 and the KPI extractor program 40 may reside on the server 12. Other configurations are possible.

The server 12 may also communicate with one or more external devices 14 such as a keyboard, a pointing device, a display 24, etc.; one or more devices that enable a user to interact with the server 12; and/or any devices (e.g., network card, modem, etc.) that enable the server 12 to communicate with one or more other computing devices. Such communication can occur via Input/Output (I/O) interfaces 22. The server 12 can communicate with one or more networks, such as network 13, via network adapter 20. As depicted, the network adapter 20 communicates with the other components of the server 12 via bus 18. Although not shown, other hardware and/or software components could be used in conjunction with the server 12. Examples, include, but are not limited to: microcode, device drivers, redundant processing units, external disk drive arrays, RAID systems, tape drives, and data archival storage systems, etc.

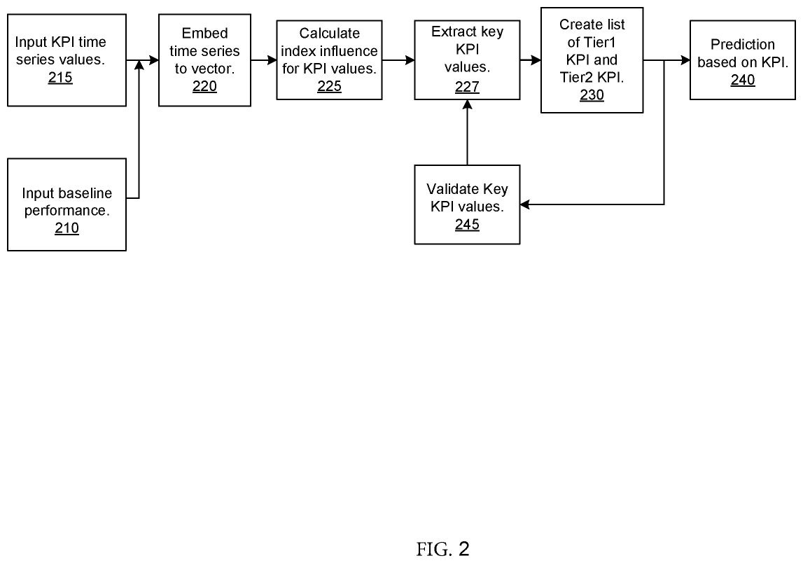

FIG. 2 illustrates a workflow of the KPI extractor program 40 of the KPI extraction system 100.

At 210, the baseline performance of the target operating system, server, or application is input. A baseline is a known value against which later measurements and performance can be compared. The baseline establishes what is normal and abnormal for the system, and may be established using any performance measurement tools. At 215, KPI extraction program 40 receives KPI time series values from the CDP 10. The CDP 10 is installed and runs on one or more of the servers 12 and collects operational data from one or more applications and operating systems on one or more servers 12. The CDP 10 may be a component of the server 12 operating system or a standalone application. A configuration profile and parameters may set the type of KPI to collect, e.g., logs from a database management system, performance records from an application, etc., and the time range of collection, such as 10 minutes.

At 220, the KPI extractor program 40 embeds the time series data, creating a vector of KPI names and values. Executing any one of the various time series software packages or languages providing time series libraries may embed the time series data to vector.

At 225, the KPI extractor program 40 calculates an index influence value for each of the KPI values in the vector. Any statistical method to calculate the index of influence may be used, for example, building the prior distribution of the regression coefficients. The KPI extractor program 40 calculates a posterior probability distribution for both inclusion and coefficients. The prior distribution of the regression coefficients and the posterior probability distribution calculations are performed using standard statistical procedures. The posterior probability distribution for both inclusion and coefficients calculation is repeated using Markov chain Monte Carlo technique. The Markov chain Monte Carlo calculations yield a posterior distribution of the variable inclusion in the model, the regression coefficient values, and the corresponding prediction of the variable inclusion in the model.

The result (at 227) are a spike and slab representation of the key KPI values. The spikes are the key KPI values.

At 230, the KPI extractor program 40 takes the key KPI values and creates a multi-tier list of key KPI values. For example, a normal distribution model may divide the key KPI values into tiers. A configuration parameter may specify how many of the key KPI values are the core values of tier1, and which, if any, comprise tier2 and any subsequent tiers.

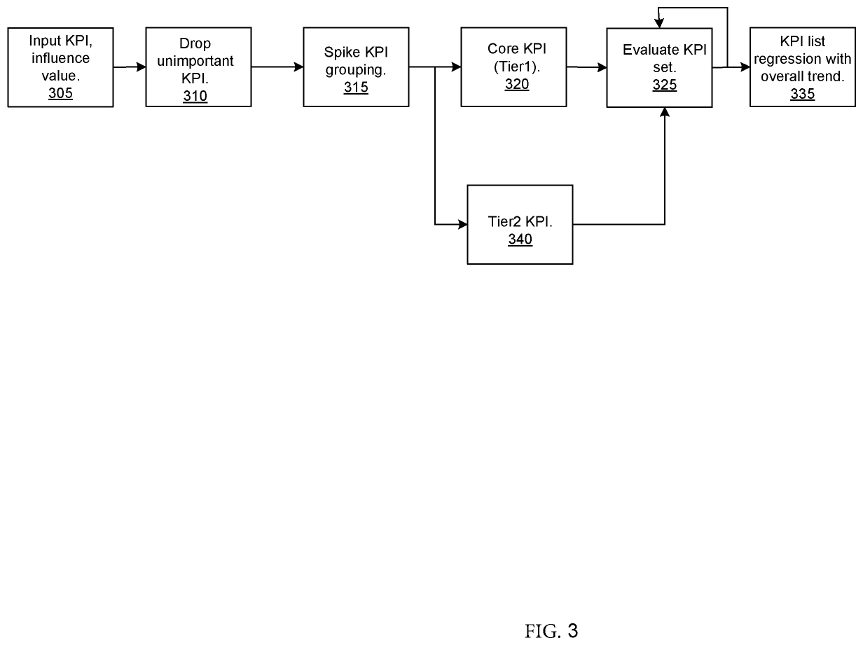

At 245, the KPI extractor program 40 validates key KPI values, as discussed further with reference to FIG. 3. The processes at 245, 227 and 230 are performed in a loop when the absolute error is above a threshold percentage. The threshold percentage, e.g., 5%, may be set as a configuration parameter. At 240, the KPI extractor program 40 identifies the KPI value with the least cumulative absolute error. This KPI value is predicted to influence system performance.

FIG. 3 illustrates a workflow of the KPI validation portion of the KPI extraction system 100. The KPI validation program uses the Bayesian Structured times Series method to validate the key KPI values. The KPI validation program may be another instance of a program 40 of FIG. 1, comprising of modules 42, or may be an instance of modules 42 of the KPI extractor program 40. The Kalman filter technique for time series decomposition is used to estimate trending. The Spike and Slab Regression is used to select the more important regression predictors. Bayesian Model Averaging is used to combine the results and to plot the cumulative absolute prediction errors for all models.

At 305, the KPI validation program takes as input the key KPI values extracted in 227 of FIG. 2. At 310, the unimportant key KPI values are dropped. The unimportant key KPI values are the slabs from the spike and slab calculations of 227 of FIG. 2.

At 315, the spikes are grouped into tiers, as in 230 of FIG. 2. At 325, for each tier, the KPI validation program compares the cumulative absolute error to the configured threshold value. Redundant key KPI values are dropped from the model. For key KPI values below the configured threshold, the index influence value is used in the Bayesian Model Averaging (335) to predict the overall trend. Each tier (320, 340) is similarly processed. Therefore, the combination of the KPI validation program and the KPI extraction program 40 is self-adaptive in determining key KPI variables in time series.

Various embodiments of the invention may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although preferred embodiments have been depicted and described in detail herein, it will be apparent to those skilled in the relevant art that various modifications, additions, substitutions and the like can be made without departing from the spirit of the disclosure, and these are, therefore, considered to be within the scope of the disclosure, as defined in the following claims.

What is claimed is:

1. A method for key performance indicator (KPI) extraction, comprising:
receiving a baseline value;
receiving time series data, wherein the time series data includes logs, performance data, and operational data from one or more servers;
embedding the time series data to a vector;
creating a multi-tier list of key KPI values; and
identifying the key KPI value having a least cumulative absolute error

2. The method of claim 1, wherein redundant key KPI values are not included in calculating a key KPI value.

3. The method of claim 1, wherein the key KPI value not exceeding a configured threshold percentage parameter is included in calculating an index influence value.

4. The method of claim 1, wherein a spike in an output of an influence index vector calculation spike and slab regression is the key KPI value.

5. The method of claim 1, wherein the number of tiers in the multi-tier model is determined by a configuration parameter or by applying a normal distribution model.

6. The method of claim 1, wherein the identifying the key KPI value having a least cumulative absolute error further comprises:
a Bayesian Model Averaging combining results of validation and plotting cumulative absolute prediction errors for all models; and
outputting a model having a least cumulative absolute error.

7. The method of claim 1, wherein the time series data to collect and a time range to collect is configurable.

8. A computer program product for key performance indicator (KPI) extraction, the computer program product comprising a non-transitory tangible storage device having program code embodied therewith, the program code executable by a processor of a computer to perform a method, the method comprising:
receiving a baseline value;
receiving time series data, wherein the time series data includes logs, performance data, and operational data from one or more servers;
embedding the time series data to a vector;
creating a multi-tier list of key KPI values; and
identifying the key KPI value having a least cumulative absolute error.

9. The computer program product of claim 8, wherein redundant key KPI values are not included in calculating a key KPI value.

10. The computer program product of claim 8, wherein the key KPI value not exceeding a configured threshold percentage parameter is included in calculating an index influence value.

11. The computer program product of claim 8, wherein a spike in an output of an influence index vector calculation spike and slab regression is the key KPI value.

12. The computer program product of claim 8, wherein the number of tiers in the multi-tier model is determined by a configuration parameter or by applying a normal distribution model.

13. The computer program product of claim 8, wherein the identifying the key KPI value having a least cumulative absolute error further comprises:
a Bayesian Model Averaging combining results of validation and plotting cumulative absolute prediction errors for all models; and
outputting a model having a least cumulative absolute error.

14. The computer program product of claim 8, wherein the time series data to collect and a time range to collect is configurable.

15. A computer system for key performance indicator (KPI) extraction, comprising:
receiving a baseline value;
receiving time series data, wherein the time series data includes logs, performance data, and operational data from one or more servers;
embedding the time series data to a vector;
creating a multi-tier list of key KPI values; and
identifying the key KPI value having a least cumulative absolute error.

16. The computer system of claim 15, wherein redundant key KPI values are not included in calculating a key KPI value.

17. The computer system of claim 15, wherein the key KPI value not exceeding a configured threshold percentage parameter is included in calculating an index influence value.

18. The computer system of claim 15, wherein a spike in an output of an influence index vector calculation spike and slab regression is the key KPI value.

19. The computer system of claim 15, wherein the number of tiers in the multi-tier model is determined by a configuration parameter or by applying a normal distribution model.

20. The computer system of claim 15, wherein the identifying the key KPI value having a least cumulative absolute error further comprises:
a Bayesian Model Averaging combining results of validation and plotting cumulative absolute prediction errors for all models; and
outputting a model having a least cumulative absolute error.
